(19) United States
(12) Patent Application Publication
(10) Pub. No.: US 2002/0140819 A1
(43) Pub. Date: Oct. 3, 2002

(54) Customizable security system component interface and method therefor

(75) Inventors: Glenn Waehner, Fresno, CA (US); Albert T. Dodrill, Airmont, NY (US)

Correspondence Address: Alan M. Weisberg, Christopher & Weisberg, P.A., Suite 2040, 200 East Las Olas Boulevard, Fort Lauderdale, FL, 33301, US

(73) Assignee: Pelco

(21) Appl. No.: 10/114,888

(22) Filed: Apr. 2, 2002

Related U.S. Application Data
(60) Provisional application No. 60/280,875, filed on Apr. 2, 2001.

(51) Int. Cl. H04N 5/225; H04N 7/18

(52) U.S. Cl. 348/207.1; 348/159

(57) ABSTRACT

A video security system comprising the first device being configured to receive control signals and having an identifier associated therewith. A second device being operable to transmit control signals to the first device. The second device comprising a component interface configured to be electrically connected to the first device. The component interface being configured to receive the identifier of the first device and to transmit control signals to the first device. At lease one stored key map being configured to selectively transmit the control signals to the first device based on the identifier of the first device and selection of the device to be controlled.

### CROSS-REFERENCE TO RELATED APPLICATION

This application is related to and claims priority to U.S. Provisional Application Serial No. 60/280,875, filed Apr. 2, 2001, entitled VIDEO SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to security systems such as closed circuit television (CCTV) systems, and in particular, to a method and system for customizing certain component data communication parameters based on the type of device interconnected thereto.

### BACKGROUND OF THE INVENTION

As the need for security systems increases, so too does the need for additional types of components, features, and enhancements to these systems. Unfortunately, with increasing complexity comes the requirement for additional user and installer training and often the requirement for still more system components to support those being installed. For example, the installation of a digital video recorder as part of a CCTV security system may also require an installation of a separate control unit, such as a dedicated keyboard, to allow an operator to configure and control the recorder. This keyboard may be in addition to other keyboards installed to configure and control other system components such as matrix switches. The result is a security system which includes duplicative components, such as keyboards. This unnecessarily increases system cost and unnecessarily increases the space requirements of the system. It is therefore desirable to have system components which allow sharing of other disparate components to minimize the number of total system components.

By way of particular example, CCTV security systems often use multiplexors such as those sold by Pelco® to display the images captured by multiple cameras on a single monitor or record the multiple images on a recording device such as a tape recorder, digital video recorder, and the like. For example, a multiplexor may support nine cameras and simultaneously display the nine images as “thumbnails” on a single monitor. In other words, multiplexors provide for multiple camera inputs and a single or multiple video outputs.

Multiplexors are often connected to larger switching devices such as matrix switching devices offered by Pelco®. Matrix switches provide the ability to accept multiple inputs and switch these inputs among multiple outputs. As such, a matrix switch may support multiple multiplexors and switch the outputs of the multiple multiplexors to one or more monitors, recorders, etc.

The matrix switches are operated by a user via a keyboard controller in which the keys and switches are used to send specific matrix switch commands to the matrix switch. Similarly, the multiplexors have their own keyboards which are arranged to provide a particular set of control commands to the multiplexors. In this type of arrangement, multiple keyboards are needed to separately program and control the multiplexors and matrix switches. The problem becomes even further exacerbated when other types of devices are added to the system.

Further, operators often become comfortable with a particular type of controller and do not want to learn the layout and nuances associated with a different controller. Similarly, an operator's response to an emergency signal can be delayed if the operator must locate the controller corresponding to the component the operator wants to use.

It is therefore desirable to be able to control and configure the multiplexor and matrix switch via a single keyboard control unit without the need to change keyboards, adjust mechanical switches on the unit or unit's keyboard, and the like. Additionally, it is desirable to be able to control and configure the matrix switch and various other devices via a single keyboard control unit.

### SUMMARY OF THE INVENTION

According to one aspect, the present invention provides a video security system in which a first device has a corresponding identifier and is configured to receive control signals corresponding to a key map. Further provided is a second device operable to transmit control signals to the first device. The second device has a component interface electrically connected to the first device and is adapted to transmit control signals to the first device. The second device has a memory storing at least one key map corresponding to the first device and a central processing unit electrically coupled to the component interface and the memory. The second device is programmed to determine the identifier of the first device, select the stored key map corresponding to the identifier and instruct the component interface to transmit at least one control signal to the first device corresponding to the selected key map.

According to another aspect, the present invention provides a video security apparatus in which a component interface is operable to transmit control signals. A memory is adapted to store at least one key map corresponding to a device to be controlled. A central processing unit is electrically coupled to the component interface and the memory. The central processing unit is configured to execute a software program which performs the functions including: determining an identifier of the device to be controlled, selecting the stored key map corresponding to the determined identifier, and instructing the component interface to transmit at least one control signal to the device to be controlled corresponding to the selected key map.

According to still another aspect, the present invention provides a method for controlling a video security system in which at least one key map corresponding to at least one device to be controlled is stored. An identifier corresponding to the device to be controlled is determined. The stored key map corresponding to the determined identifier is selected and at least one control signal is transmited to the device to be controlled corresponding to the selected key map.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system constructed in accordance with the principles of the invention;

FIG. 2 is a diagram of a keyboard unit configured to control a matrix switch;

FIG. 3 shows a keyboard unit configured to control a multiplexor;

FIG. 4 is a block diagram of an exemplary switch; and

FIG. 5 is a flowchart describing a function of the invention.

### DETAILED DESCRIPTION OF THE INVENTION

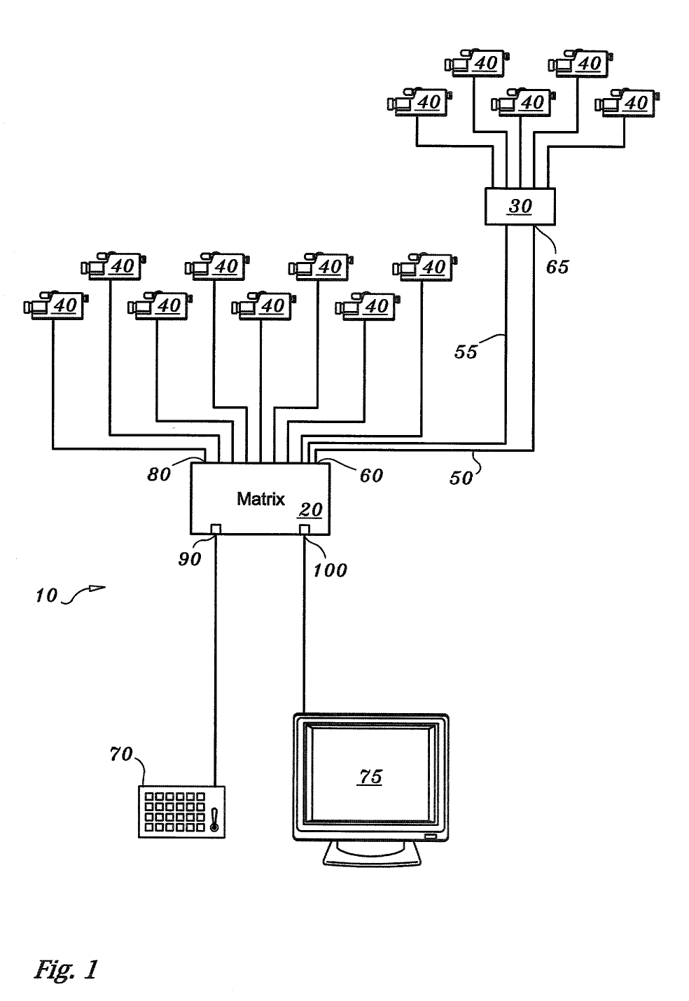

Referring now to the drawing Figures in which like reference numerals refer to like elements, there is shown in FIG. 1 a system 10 constructed in accordance with the principles of the present invention. The system 10 preferably includes a matrix switch 20 in communication with one or more accessory devices 30. The matrix switch 20 is electrically connected to at least one camera 40. Further, electrically connected to the matrix switch 20 is at least one control keyboard 70 and at least one monitor 75. For purposes of illustration, FIG. 1 shows an exemplary system having eight cameras 40 connected to the matrix switch 20 via matrix input ports 80, one keyboard 70 connected to the matrix switch 20 via control port 90, one monitor 75 connected to the matrix switch 20 via a video port 100, and one accessory device 30 connected to the matrix switch 20 via a component interface 60.

The system 10 is configured to allow a user to use the keyboard 70 to instruct the matrix switch 20 to switch between components connected thereto, such as a camera 40. Images are received from the selected camera 40 and are then routed by the matrix switch 20 to the monitor 75 for viewing. The keyboard 70 can be used to select input devices or to control functions of the matrix and/or user operable camera platforms, such as pan and tilt devices. The component interface 60 of the matrix switch 20 when connected to the accessory device 30, can communicate commands to the accessory device 30 to operate functions thereof. For example, selecting the format or sequence of data to be transmitted from the accessory device. The matrix switch 20 and the accessory device 30 are connected by link 50 which is configured to transmit and receive communicative signals to and from matrix switch 20 and accessory device 30 and video link 55 which is configured to communicate video signals. An exemplary link 50 is an RS232 or RS422 data cable. Further provided is a video link 55 configured to carry video signals from the accessory device 30 to the matrix switch 20. It is contemplated that alternate embodiments can use the video link 55 to communicate both the video signal and the control signals using presently available technologies. An exemplary video link 55 is a coaxial cable. Additionally, camera 40 can have one or more links thereto. For example, the camera 40 can have one link for control signals and another for video data (not shown). Alternatively, the camera 40 can have a single link for transmitting and receiving both control and video signals.

An accessory device 30 is preferably a device which can be configured through user operable controls. An example of a user operable control is a keyboard or keypad input device. An accessory device is configured to receive control commands through a control interface 65 which are then processed by the accessory device to control various functions thereof. An exemplary accessory device 30 is a video multiplexing unit as shown in FIG. 1. Arranged as a video multiplexing unit, the accessory device 30 allows video input from one or more cameras 40 to be split into multiple views on one display screen, as described herein.

The present invention advantageously provides an efficient way for an operator to set up and configure a system 10 constructed in accordance with the principles of the invention. When an accessory device 30 is connected to the component interface 60 an appropriate set of control codes are enabled so that the matrix switch 20 can send signals to control the functions of the accessory device 30 in a format recognizable by the accessory device 30. Provided is a set of available control protocols which are stored in the matrix switch 20. When an operator desires to configure the control protocol for the attached accessory device, he has the option of selecting the device to be configured from a menu displayed on the monitor 75. When the operator chooses a desired accessory device 30 from the menu, the matrix switch 20 selects the control protocol corresponding to that accessory device 30. The matrix switch 20 then saves the protocol and identification of the selected accessory device 30 in a memory location which corresponds to that accessory device 30. In this manner, the matrix switch can be configured to control various accessory devices when attached to the component interface.

The present invention further provides the matrix switch 20 with a translation function to enable the matrix switch 20 to communicate with accessory devices 30 from various manufacturers. Users may implement equipment in their system which has been manufactured by different vendors. As such, a security system may implement accessory devices having many different protocols for communication. Most often, if two devices are not made by the same vendor, they can not communicate with one another without using an additional device such as a translation module. When an accessory device is connected to the component interface of the present invention, if it does not utilize the same control protocol as the matrix switch, the operator has the option to select a translation function corresponding to the accessory device. As such, the translation function enables the matrix switch 20 to control the accessory devices of other manufacturers without using a separate translation module.

The matrix switch 20 can be configured to store a selection of available translation protocols in the form of different key maps. The operator is presented with a menu from which to select the accessory device attached to the component interface 60. Once the operator selects the desired accessory device, the matrix switch selects and uses the key map corresponding to the selected device when communicating therewith.

Further, an alternate embodiment of the present invention advantageously provides a way for matrix switch 20 to identify the type of device connected to component interface 60, either by manual selection performed by an operator as described above or automatically by the matrix switch 20. In accordance with an aspect of the present invention, the component interface 60 is polled by the video matrix switch 20. The polling signal is transmitted to the accessory device 30 which responds by transmitting to the switch 20, characteristic data which identifies the device, such as model number, software version, capabilities, manufacturer, and the like. In this manner, the matrix switch 20 is able to identify the existence and characteristics of the accessory device 30. For example, the matrix switch 20 can poll the component interface 50 and determine that a device connected thereto is a multiplexor.

Alternatively, through link 50, the matrix switch is able to detect the presence of an accessory device 30. As such, the system operates to allow a user to control and program the accessory device 30 with the matrix switch keyboard 70. The configuration of the matrix switch 20 to control the accessory device 30 can either be programmed by the user via user interfaces associated with the matrix switch 20, or the system can be set up to perform an auto-configuration. For example, system 10 can be configured such that the matrix switch 20 is programmed by an operator via onscreen menus to select the specific accessory device connected to the component interface 60. Alternatively, when an operator switches the matrix switch 20 from one state to access the data coming in through the video link 55, the matrix switch 20 can reconfigure itself automatically to remap the control keyboard to control whatever device is sending such data.

As still another alternative, the matrix switch 20 can be configured to automatically detect when the component interface is connected to an accessory device and to receive a data packet from such device relaying characteristics and configuration parameters thereof. In this manner, the matrix switch 20 can identify when and what type of an accessory device is coupled to the component interface 60.

Further, when the matrix switch 20 is configured to automatically detect the attached accessory device and an accessory device from a different manufacturer is attached, it can also be configured to automatically select the appropriate translator for the accessory device. Thereby, advantageously providing the function of automatically selecting an appropriate translator to control other manufacturers devices.

In another embodiment, the matrix switch 20 is configured to determine what type of device is coupled to component interface 60. Because the matrix switch 20 maintains keyboard mapping information in memory, the matrix switch 20 can reconfigure or remap its keyboard to efficiently control the detected accessory device 30. Such remapping can be accomplished either manually or automatically by the matrix switch. Exemplary keyboard mapping comprises the use of a hexadecimal code to allow an input device to communicate which of its individual switches has been actuated and to assign a function thereto. For example, if the “a” button is depressed on a keyboard, a specific code is sent to the matrix switch such as 4Aₕₑₓ. The present invention provides for changing the activated functionality associated with the code assigned to each individual key or keyboard switch. For example, if the keyboard is mapped to control the matrix switch, then the hexadecimal code for 4Aₕₑₓ may correspond to one function, and when the keyboard 70 is configured to control the accessory device, the code 4Aₕₑₓ will correspond to a different component function.

In the exemplary embodiment shown in FIG. 1, a multiplexing unit is the accessory device discussed. Typically, the use of a multiplexing unit requires a dedicated keyboard or input device to program and control the functionality of the unit. In the system of the present invention, the separate input device for the multiplexing unit is eliminated and appropriate control signals are received from the matrix switch via link 50. Further, data output such as video signals from the accessory device 30 are relayed to the matrix switch via a video link 55. Under this arrangement, the need for an additional keyboard to control the functions of the multiplexing unit is advantageously eliminated.

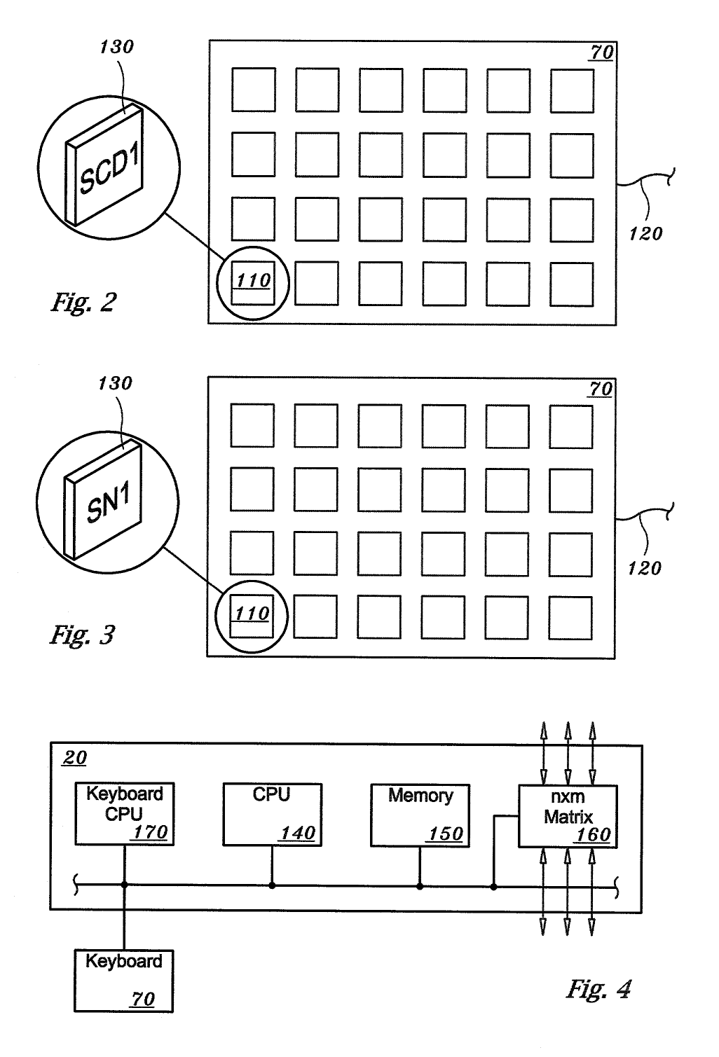

FIG. 2 shows a keyboard unit 70 having multiple control keys 110 and a data line 120 which is connected to the control port 90 for the matrix switch 20 as shown in FIG. 1. Since the present invention provides for multiple devices to be controlled by a single controller or set of controllers such as one or more keyboard controllers, it is desirable to provide a way for a master keyboard to control the different functions of the different devices without a cumbersome inordinate number of keys and/or switches. As such, a system and device for storing and later recalling keyboard mapping data is provided.

FIGS. 2 and 3 show an exemplary keyboard used in association with the present invention with magnified views of a selected control key for illustration purposes along with alternate key maps for controlling the matrix switch 20 and the accessory device 30 respectively. The keyboard shown in FIGS. 2 and 3 is an exemplary type which has electronically alterable individual display units integrated with each key. For example, the keys 110 are each integrated with a liquid crystal display (LCD) or light emitting diode (LED) display, each of which can be configured to indicate the function for which the key is mapped to control at a given time. It is contemplated that other key function schemes can also be used. For example, an overlay for standard keys can be used, or the “keyboard” itself can be configured on a pressure sensitive display which shows a representation of a keyboard thereon.

In addition to the alternate embodiments of keyboards discussed above, other alternate embodiments are contemplated as well. For example, the layout of the keyboard can be such that it provides variable keys or soft-keys which can be reprogrammed according to the device selected to be controlled and are reconfigurable to control alternate functions of the various devices. The soft-keys can be linked to the specific device which has been selected for control. In the alternative the soft-keys can be linked to the type of device to be controlled. For example, if the keyboard is configured to control a class of device such as a recorder, then the soft-keys would control functions such as play, record, fast-forward, rewind, etc. However, when the keyboard is reconfigured to control a different class of device, such as a multiplexor, then those same keys would be reprogrammed to control functions such as 4 screen view, 16 screen view, etc. As such, the present invention advantageously provides for a system which allows a limited number of available keys to control a large number of possible functions of multiple devices.

Another alternate embodiment of a keyboard configuration provides for dedicated keys which always have the same function associated with them for a corresponding device. For example, a keyboard can have an arrangement of keys for controlling a specific class of devices, such as recorders or multiplexors. For keys configured to control a recorder, dedicated keys to control the play, record, fast-forward and rewind functions are provided. Whenever a recorder class device is selected for control, the dedicated keys are activated for use therewith. It will be readily understood that a keyboard 70 can be provided which has several sections of dedicated keys for controlling different accessory devices 30. Further, not all of the dedicated keys have to be activated at any given moment. For example, if a recorder class of device is selected for control, then the multiplexor dedicated keys may not be active. As such, the present invention provides a keyboard arrangement which controls various devices with keys which are consistently the same, thereby increasing ease of use by an operator.

FIG. 2 shows an exemplary keyboard configuration arranged to control the matrix switch 20. For example, exemplary input key 130 is shown in a matrix switch control mode and is configured to activate a preprogrammed sequence number (SN) in the matrix switch 20. An exemplary SN can be a sequential viewing of the video image from a series of selected cameras for a selected time period. For example, sequentially showing all of the hallways in a given structure for 30 second intervals in turn on a single display screen.

In comparison, FIG. 3 shows the same keyboard 70, wherein the keyboard is configured to control the functionality of the accessory device 30. Comparing key 120 to FIG. 2 it is seen here that key 120 is configured to instruct the matrix to instruct the accessory device 30 to activate a preprogrammed sequential camera display (SCD). An exemplary SCD is the sequential display of all of the cameras 40 which are feeding video signals to the accessory device 30 in a specific order on one screen.

FIG. 4 is a block diagram showing an exemplary component arrangement of the matrix switch 20 having a central processing unit (CPU) 140, a memory storage unit 150 and an N×M matrix 160. It will be readily understood by one skilled in the art that the size and type of CPU can be selected based on the size and requirements of the system. An exemplary CPU can be a microcontroller or the type found in a mainframe computer, personal computer or other such device. An exemplary memory storage unit 150 is a random access memory (RAM) that stores data in digital form. Alternative examples of a memory storage unit 150 are electrically erasable programmable read only memory (EEPROM), flash RAM, magnetic hard drive, optical hard drive and other such storage devices which are known in the art. An N×M matrix 160 refers to the type of matrix switch which has multiple inputs for receiving video signals (N) from video sources, such as cameras, and multiple outputs for transmitting video signals (M) to viewing devices, such as monitors. The N×M matrix 160 can be configured to selectively display the video signal from one or more cameras on one or more monitors. For example, the video image from a camera can be switched to be viewed on a monitor. In this manner, an operator can selectively view video from various cameras or input devices on various monitors.

Further provided is a keyboard interface 170 and a keyboard 70 attached thereto. In an exemplary use of the matrix switch 20, an operator uses keyboard 70 to instruct the matrix switch 20 as to which keyboard configuration (key map) should be activated and as to which device should be controlled thereby. For example, in a first configuration, the keyboard unit 70 is used to instruct the keyboard interface 170 within the matrix switch 20 to adopt a matrix switch control configuration. This instruction is stored in a memory storage unit 150 which allows the operator to use the keyboard 70 to control the matrix switch 20. When desired, the operator can use the keyboard 70 to instruct the keyboard interface 170 to adopt a second keyboard configuration (key map)which is configured to control the accessory device 30 and its functionality, which instructions are again stored in the memory storage device 150. By this arrangement, an operator can use the same keyboard unit 70 to control both the matrix switch 20 and any other accessory devices attached thereto, e.g. a multiplexor as discussed herein. Of course, keyboard interface 170 and CPU 140 can be implemented as a single device.

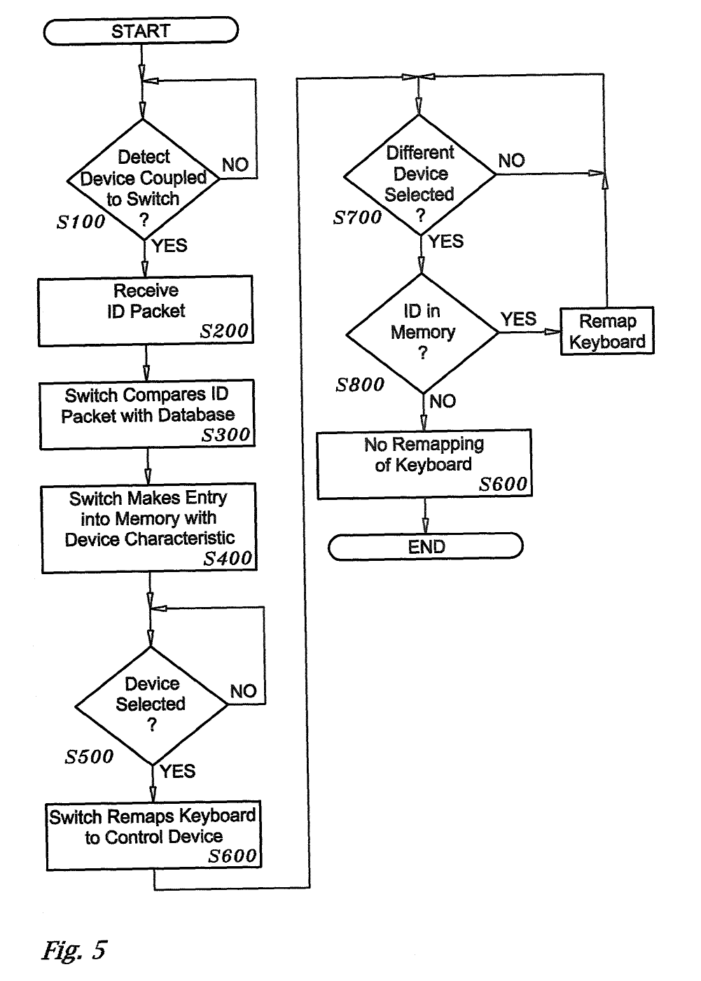

FIG. 5 shows a flowchart, illustrating exemplary steps that the matrix switch 20 performs when an accessory device 30 is connected to the component interface 60. When an accessory device 30 is connected to the matrix switch 20 via the component interface 60, the matrix switch 20 thereby detects that the accessory device 30 is connected thereto (Step S100). As noted above, step S100 can be accomplished by many different methods. An exemplary method includes the above described arrangement of periodically polling the component interface 60 to detect the presence of an electrically-connected accessory device 30. Alternatively, as described above, the accessory device 30 can be configured to send an electrical signal to the component interface 60 to notify the matrix switch 20 of its connection and/or configuration.

If the matrix switch 20 determines that an accessory device 30 is connected thereto, the matrix switch 20 is set to receive an identification packet from the accessory device 30 (Step S200). The identification packet from the accessory device 30 informs the matrix switch 20 of its specific configuration and requirements for control functions. The matrix switch 20 then compares the identification packet received from the accessory device 30 to stored data in its memory (Step S300). If the matrix switch 20 determines that the identification packet received from the accessory device 30 is already stored in its memory, the matrix switch moves to the next step. If, however, the matrix switch determines that such an identification packet does not exist in its memory, it will enter the information contained in the identification packet into its memory (Step S400). Exemplary information that is stored is accessory device configuration, accessory device control signal requirements and specific keyboard maps for a given accessory device.

The matrix switch 20 determines whether the accessory device has been selected by an operator using keyboard 70 (Step S500). When an accessory device 30 has been selected by the operator, the matrix switch 20 remaps the keyboard 70 to control the accessory device 30 using data stored in its memory (Step S600). The matrix switch 20 continues to monitor the component interface 60 for the selection of a different matrix port or input device (Step S700). If a different device or input port is not selected, the matrix switch 20 continues to monitor the component interface 60. If a different matrix input or accessory device is selected, the matrix switch 20 determines if the identification packet and/or information for the selected device is stored in its memory (Step S800). If the identification information is stored in its memory, then the matrix switch 20 remaps the keyboard to control such device (Step S900) and then returns to the beginning of Step S700. If the identification information is not stored in the matrix switch 20's memory, then no remapping of the keyboard is performed (Step S1000).

Although the embodiment above describes the use of a multiplexor as an accessory device, it is contemplated that other accessory devices can be coupled to component interface 60. For example, another exemplary accessory device is a digital video recorder (“DVR”). DVR systems that are available today have many functions that require specific instructions and user programming. This level of user interaction requires a separate keyboard. As such, the system of the invention can be used with a DVR system to eliminate the DVR's separate keyboard or input device, as described above. Further, it is contemplated that more than one component interface 60 can be provided. Further, still, an alternate arrangement is to transmit the special input signals along the same interfaces used for camera connections. This provides the same functionality as having a component interface 60 but allows the accessory device to be connected to any of the matrix switch input jacks.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A video security system comprising:
a first device, the first device having a corresponding identifier and being configured to receive control signals corresponding to a key map;
a second device operable to transmit control signals to the first device, the second device comprising:
a component interface electrically connected to the first device and adapted to transmit control signals to the first device; and
a memory storing at least one key map, at least one of the stored key maps corresponding to the first device;
a central processing unit electrically coupled to the component interface and the memory, the central processing unit executing a software program which performs functions including:
determining the identifier of the first device;
selecting the stored key map corresponding to the determined identifier; and
instructing the component interface to transmit at least one control signal to the first device corresponding to the selected key map.

2. The video security system of claim 1, wherein the first device is a video multiplexing unit.

3. The video security system of claim 1, wherein the first device is a digital video recorder.

4. The video security system of claim 1, wherein the second device is a video matrix switch.

5. The video security system of claim 1 further comprising a controller configured to send control signals to the second device, the controller having reconfigurable control keys control alternate functions of the first device.

6. The video security system of claim 1 further comprising a controller configured to send control signals to the second device, the controller having control keys dedicated to controlling a specific function of the first device independent of the manufacturer of the first device.

7. The video security system of claim 1, wherein selecting the key map includes:
a user manually selecting the first device; and
instructing the second device to use the key map corresponding to the first device.

8. The video security system of claim 1, wherein the selection of the key map is performed automatically by the second device when the identifier is received from the first device via the component interface.

9. The video security system of claim 8, wherein the central processing unit further performs the function of polling the first device, the polling including transmitting a request to the first device for the identifier.

10. The video security system of claim 1 further comprising a controller electrically coupled to the second device, the controller being configured to transmit an instruction signal corresponding to a user actuated switch to the second device, wherein the instructing function performed by the central processing unit further includes:
receiving the instruction signal; and
evaluating the selected stored key map to determine the control signal corresponding to the instruction signal.

11. The video security system of claim 10 wherein the controller is a keyboard controller having at least one user actuatable switch.

12. A video security apparatus comprising:
a component interface operable to transmit control signals;
a memory storing at least one key map, at least one of the stored key maps corresponding to a device to be controlled;
a central processing unit electrically coupled to the component interface and the memory, the central processing unit executing a software program which performs functions including:
determining an identifier of the device to be controlled;
selecting the stored key map corresponding to the determined identifier; and
instructing the component interface to transmit at least one control signal to the device to be controlled corresponding to the selected key map.

13. The video security apparatus of claim 12, wherein the apparatus is a video matrix switch.

14. The video security apparatus of claim 12 further comprising a controller configured to send control signals, the controller having reconfigurable control keys to control alternate functions of the device to be controlled.

15. The video security apparatus of claim 12 further comprising a controller configured to send control signals, the controller having control keys which are dedicated to controlling a specific function of the device to be controlled independent of the manufacturer of the device to be controlled.

16. The video security apparatus of claim 12, wherein selecting the key map includes:
a user manually selecting the device to be controlled; and
instructing the use of the key map corresponding to the device to be controlled.

17. The video security apparatus of claim 12, wherein the selection of the key map is performed automatically when the identifier is received from the device to be controlled via the component interface.

18. The video security apparatus of claim 12, wherein the central processing unit further performs the function of polling the device to be controlled, the polling including transmitting a request to the device to be controlled for the identifier.

19. The video security apparatus of claim 12 further comprising: a controller electrically coupled thereto, the controller being configured to transmit an instruction signal corresponding to a user actuated switch, wherein the instructing function performed by the central processing unit further includes:
receiving the instruction signal; and
evaluating the selected stored key map to determine the control signal corresponding to the instruction signal.

20. A method of controlling a video security system comprising the steps of:
storing at least one key map corresponding to at least one device to be controlled;
determining an identifier corresponding to the device to be controlled;
selecting the stored key map corresponding to the determined identifier; and
transmitting at least one control signal to the device to be controlled corresponding to the selected key map.

21. The method of controlling a video security system of claim 20, wherein selecting the stored key map includes:
a user manually selecting the device to be controlled; and
instructing the use of the key map corresponding to the device to be controlled.

22. The method of controlling a video security system of claim 20, wherein the selection of the key map is performed automatically when the identifier is received from the device to be controlled.

23. The method of controlling a video security system of claim 20, further comprising;
polling the device to be controlled, the polling including transmitting a request to the device to be controlled for the identifier.

24. The method of controlling a video security system of claim 20, further including:
receiving the instruction signal; and
evaluating the selected stored key map to determine the control signal corresponding to the instruction signal.
